(19) United States
(12) Patent Application Publication
(10) Pub. No.: US 2007/0153306 A1
(43) Pub. Date: Jul. 5, 2007

(54) Tone-mapping method for reducing memory requirements

(75) Inventor: Chan-Min Chou, Hsinchu City (TW)

Correspondence Address: BIRCH STEWART KOLASCH & BIRCH, PO BOX 747, FALLS CHURCH, VA, 22040-0747, US

(73) Assignee: Altek Corporation

(21) Appl. No.: 11/449,763

(22) Filed: Jun. 9, 2006

(30) Foreign Application Priority Data
Dec. 30, 2005 (TW) 094147562

(51) Int. Cl. G06K 15/00; G06F 15/00

(52) U.S. Cl. 358/1.9; 358/1.16

(57) ABSTRACT

A tone-mapping method for reducing memory requirements is provided. If an input address is smaller than a first critical address, it is directly looked up in a tone-mapping table to correspond the input address to an actual output. If the input address is larger than the first critical address, it is then determined whether the input address is larger than a second critical address or not. If it is not larger than the second critical address, two adjacent sample addresses are taken to correspond the input address to an actual output. If the input address is larger than the second critical address, four adjacent sample addresses are taken to correspond the input address to an actual output.

### CROSS-REFERENCE TO RELATED APPLICATIONS

This non-provisional application claims priority under 35 U.S.C. §119(a) on Patent Application No(s). 094147562 filed in Taiwan, R.O.C. on Dec. 30,2005, the entire contents of which are hereby incorporated by reference.

### BACKGROUND OF THE INVENTION

1. Field of Invention

The present invention relates to a method for reducing memory requirements, and more particularly, to a tone-mapping method for reducing memory requirements.

2. Related Art

Gamma correction is applied in a color presentation regulation of an image input/output system, and is used for controlling image output. If image output presentation is not processed by the correction procedure, the output image usually appears dim because of a distortion occurring during signal delivery, or the chromaticity value does not achieve saturation. The procedure thereof mainly relates to adjust the color output of an image pixel using tone-mapping. The most common manner is that an action of looking up a tone-mapping table is added during the image input and output process, thereby achieving an effect of correcting the chromaticity value. An ordinary pixel substantially has three subpixels, which respectively belong to three primary colors, i.e. red, green, and blue, and the corresponding digital image pixel values thereof must be modified through red, green, and blue tone-mapping tables respectively, thereby eliminating the luminance problem of image coloration caused by the image capturing device.

For the conventional Gamma correction process, when a digital image is input, the subpixels of three primary colors resolved from a pixel will be corrected respectively by the system, to acquire a digital image pixel value. After three digital image pixel values are produced according to the color resolution respectively, they are corrected by looking up the tone-mapping tables corresponding to the colors thereof. The tone-mapping tables include multiple sets of digital image subpixel values and corresponding tone correction values. When each digital image subpixel value is input, a tone correction value corresponding to the digital image pixel value is obtained through a binary search, and then stored in a memory. Thus, a correction procedure of table-looking-up is completed. However, during each check of the table, each digital image subpixel value must averagely experience 8 binary search periods to obtain and store a corresponding tone correction value. For one digital image pixel value, it must experience 3×8 binary search periods. This result cannot satisfy the requirement for speed efficiency.

Furthermore, taking converting the input of 12 bits to 8 bits as an example, the memory requirements are 4 KB. If more tone-mapping tables are necessary, it can be imagined that a great amount of memory will be required. To reduce the size of the tone-mapping table, an ordinary solution is to adopt an Interpolation calculation, as shown in FIG. 1. The ordinary Interpolation calculation methods are various, and they are nothing else than methods applied in redistributing graphic primitives for the image. The object is to confirm the information of the void points between the known points in the image, for saving the memory space. However, more multipliers and adders are required when using the Interpolation calculation, and such a design also results in a waste in terms of hardware cost.

Therefore, a tone-mapping method for reducing memory requirements without influencing the image output effect is a subject worthy of concern.

### SUMMARY OF THE INVENTION

In view of the above problems, a main object of the present invention is to provide a tone-mapping method for reducing memory requirements. The tone-mapping method relied on the curvature characteristics of a Gamma curve carries out a tone-mapping in an allowable error range.

The present invention is first to determine whether an input address is larger than a first critical address or not. If the input address is smaller than the first critical address, it is directly looked up in a tone-mapping table to correspond to an actual output. If the input address is larger than the first critical address, it is determined whether the input address is larger than a second critical address or not. If the input address is not larger than the second critical address, two adjacent sample addresses of the input address are taken to correspond to an actual output. If the input address is larger than the second critical address, four adjacent sample addresses of the input address are taken to correspond to an actual output.

It is an advantage of the present invention that the present invention establishes a mapping relationship between source data and a target output, so as to reduce the memory requirements of the tone-mapping process.

Above illustration about the summary of the present invention and the following illustration about the detailed description of the present invention are used to exemplify and explain the principle of the present invention, and provide further explanation of the claims of the present invention.

Further scope of applicability of the present invention will become apparent from the detailed description given hereinafter. However, it must be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a tone-mapping table calculating by using an Interpolation calculation;

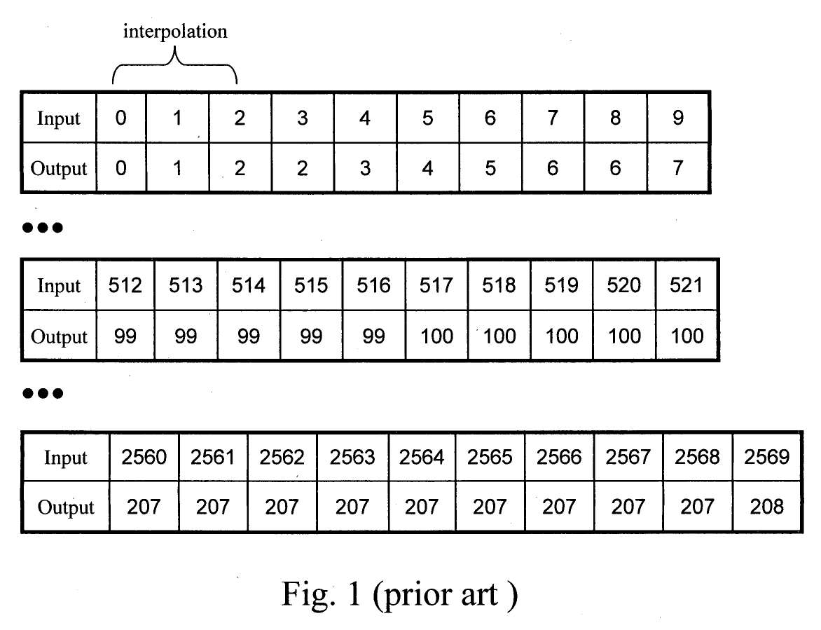

FIG. 2 is a schematic view of curvature characteristics of a Gamma curve adopted by a conventional Gamma correction;

FIG. 3 is a tone-mapping table for reducing memory requirements according to the present invention; and

FIG. 4 is a flow chart of the tone-mapping method for reducing memory requirements according to the present invention.

### DETAILED DESCRIPTION OF THE INVENTION

The characteristics and implementation related to the present invention will be illustrated in detail below with most preferable embodiments accompanied with drawings.

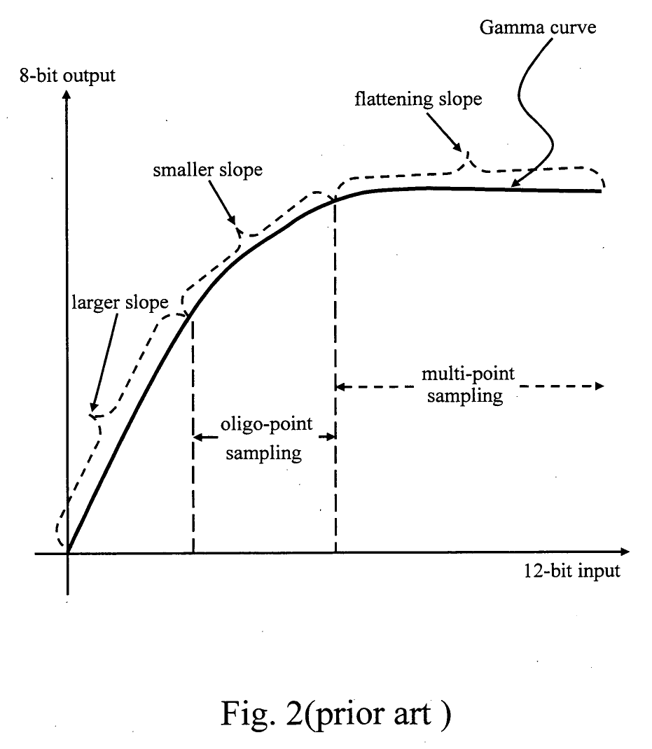

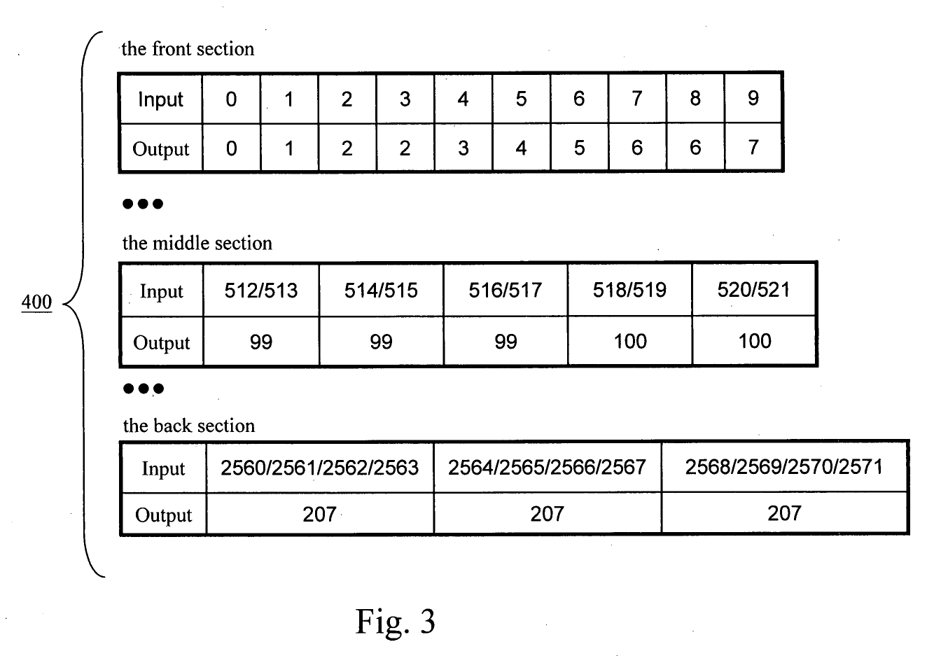

A tone-mapping method for reducing memory requirements provided by the present invention mainly makes a reasonable tone-mapping with the curvature characteristics of a Gamma curve adopted by a Gamma correction. Referring to FIG. 2, this embodiment takes as an example converting a 12-bit input to an 8-bit output, but this is not intended to limit the application scope of the present invention. The tone-mapping method is applicable for a search table converting a 10˜16-bit input to an 8-bit output. All data conversion of image or sound (16 bits) falls in the application scope of the present invention. The inherent curve slope of the Gamma curve tends to become increasingly smoother, and consequently, when it is converted to the 8-bit output, the actual output according to the back section of the curve (flattening slope) does not change too much. Therefore, the present invention provides a tone-mapping method within an allowable error range according to the curvature characteristics of the Gamma curve. Referring to FIG. 3, a tone mapping manner is adopted, wherein the front section (larger slope) maintains unchanged, the middle section (smaller slope) takes two adjacent sample input addresses (oligo-point sampling) to correspond to an output, and the back section (flattening slope) takes four adjacent sample (multi-point sampling) input addresses to correspond to an output.

Taking a search table for converting the 12-bit input to the 8-bit output as an example, a memory space of 4096 bytes is required. By using the method of the present invention, 512˜2559 takes two adjacent sample addresses to correspond to an actual output, 2560˜4096 takes four adjacent sample addresses to correspond to an actual output, and then the size of the tone-mapping table becomes 512+(2559-511)/2+(4095-2559)/4=1920 bytes, saving a half of memory space compared with the conventional memory space.

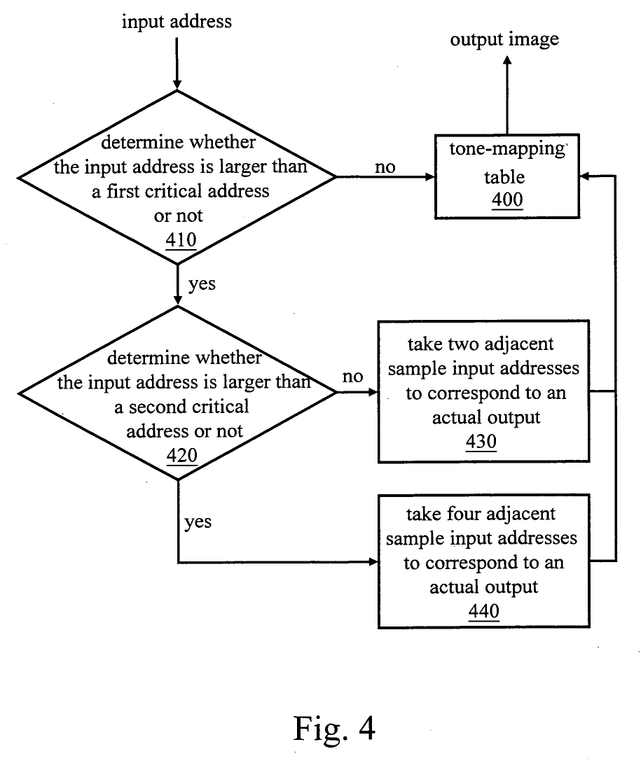

An actual method flow is as shown in FIG. 4, it determines whether an input address is larger than a first critical address or not at first (step 410). Taking the present embodiment as an example, the input address comprises binary codes. Provided that the input address is smaller than 512 (the first critical address), a tone-mapping table 400 is looked up directly to correspond to an actual output. If the input address is larger than the first critical address, it then determines whether the input address is larger than a second critical address or not (step 420). If it is not larger than the second critical address, i.e. the input address is between 512 (the first critical address) and 2560 (the second critical address), two adjacent sample addresses are taken to correspond to an actual output (step 430). If the input address is larger than 2560 (the second critical address), four adjacent sample addresses are taken to correspond to an actual output (step 440). Therefore, the design cost of the logic circuit can be saved.

Based on the design manner described above, sRGBtone(x) is used to test for proving the practicability of the present invention.

$$sRGBtone ( x ) = \{ \begin{matrix} 255 \cdot 12.95 \cdot x & if x < 0.0031308 \cdot 4095 \\ 255 \cdot 1.055 \cdot {x}^{1 / 2.4} - 255 \cdot 0.055 & if x \geq 0.0031308 \cdot 4095\end{matrix}$$

It can be known from the above equation that, the mean square error of the conventional tone-mapping table is 0.2886. The mean square error calculated by the present invention is 0.2906, with an error of about 0.06 dB compared with the conventional manner, and this is within an acceptable error range. Therefore, the practicability of the present invention is proved.

The tone-mapping method for reducing memory requirements provided by the present invention is applicable in the conventional digital image processing, music format conversion, and the like, for establishing a mapping relationship of a source data (image, music) to a target output (image, music), so as to reduce the memory requirements of the tone-mapping process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tone-mapping method for reducing memory requirements, comprising:
looking up a tone-mapping table directly when an input address is smaller than a first critical address to correspond the input address to an actual output;
determining whether the input address is larger than a second critical address or not when the input address is larger than the first critical address;
taking two adjacent sample addresses to correspond to the actual output if the input address is not larger than the second critical address; and
taking four adjacent sample addresses to correspond to the actual output if the input address is larger than the second critical address.

2. The tone-mapping method for reducing memory requirements as claimed in claim 1, wherein the tone-mapping table is applicable for a search table converting a 10˜16-bit input to an 8-bit output.

3. The tone-mapping method for reducing memory requirements as claimed in claim 2, wherein the input address comprises binary codes.
